(19) United States
(12) Patent Application Publication
(10) Pub. No.: US 2005/0235405 A1
(43) Pub. Date: Oct. 27, 2005

(54) Urinal splash eliminator

(76) Inventor: Ron Dolle, Roseville, MN (US)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(21) Appl. No.: 10/830,601

(22) Filed: Apr. 23, 2004

(51) Int. Cl. E03D 9/00; F15D 1/00

(52) U.S. Cl. 4/300.3

(57) ABSTRACT

An anti-splash device for eliminating back splash of liquid from a toilet bowl during urination. The device includes a mechanism for holding a longitudinal strip of material capable of floating on the surface of the water in the toilet bowl. At least one float can be attached to the strip of material to further help the material float on the surface of the water.

### CROSS-REFERENCE TO RELTED APPLICATION(S)

None

### BACKGROUND OF THE INVENTION

This invention relates to bathroom accessories, and more particularly to anti-splash devices for toilet bowls.

One of the most common problems that occur when men use a typical toilet to urinate is the stray splashing of water and/or urine onto the toilet bowl rim or seat. Not only does the splattering leave the toilet seats wet, but the toilet area is also left in an unpleasant and unsanitary condition. This creates tension been the sexes.

### BRIEF SUMMARY OF THE INVENTION

The present invention includes an anti-splash device for eliminating back splash from liquid, typically urine and water, when a toilet bowl is used for urination. A strip of material is attached using a suitable fastening mechanism which in turn is attached to the rim of a toilet bowl. The strip of material floats on the surface of the water in the toilet bowl. Floats are attached to one end of the strip of material to help the material remain on the surface of the water.

### BRIEF DESCRIPTION OF THE DRAWINGS

FIG. 1 is a top plan view of the present invention in use with a typical toilet bowl.

FIG. 2 is a perspective view of a fastening mechanism.

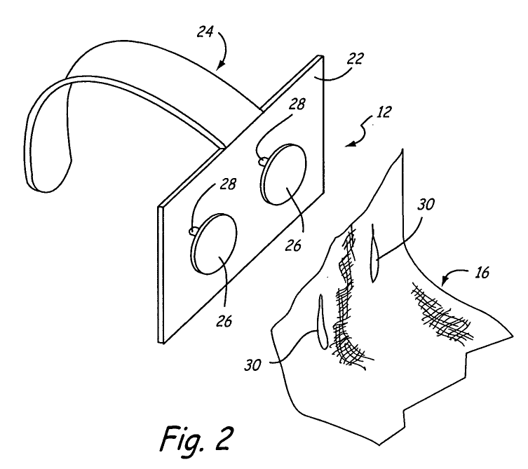

### DETAILED DESCRIPTION

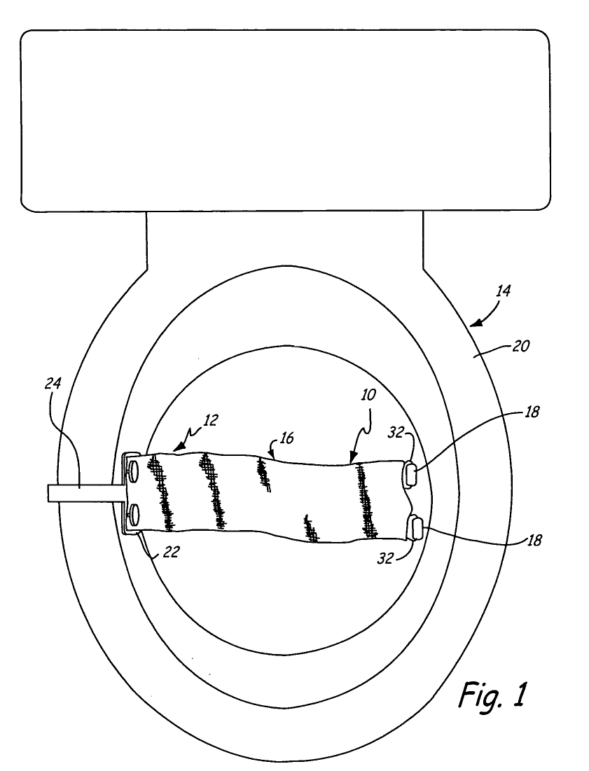

The anti-splash device of the present invention generally indicated at 10 in FIG. 1, eliminates the unwanted back spray that commonly occurs during usage of a typical toilet bowl by a male to urinate.

The anti-splash device 10 is comprised of a fastening mechanism 12 that is attached to a rim 20 of a toilet bowl 14. The fastening mechanism 12 secures a splash eliminator strip 16 to the rim 20 of the toilet bowl 14.

The fastening mechanism 12 can be any suitable mechanism for attaching the splash eliminator strip 16 to the rim 20 of the toilet bowl 14. Suitable mechanisms would include, but are not limited to, hooks, S-shaped hooks, adhesive strips and cord attachments. One suitable fastening mechanism 12 includes a hook portion 24 and a strip attaching portion 22 having a pair of raised securing buttons 26. The fastening mechanism 12 is integrally formed from plastic. The hook portion 24 acting with the securing portion 22 attaches to the rim 20 in a snap fit connection. Preferably, the securing portion 22 is flat and the buttons 26 rise from the securing portion 22 through stem portions 28. The strip 16 includes a pair of holes 30 through which buttons 26 extend to secure the strip 16 to the fastening mechanism 12.

The splash eliminator strip 16 can be of any suitable material capable of floating on or near the surface of water. Since the material is in contact with water for an extended period of time, the material has to have enough integrity to retain it's structure. The splash eliminator strip 16 in the illustrated embodiment is a commercial cleaning cloth comprising of a non-woven synthetic material. In one embodiment the cloth has been cut into a longitudinal strip of approximately 26.4 centimeters in length and approximately 5.0 centimeters in width. One criteria is that the length is greater than the width. However any strip of sufficient length and width that reduces splatter caused by a urinary stream is within the scope of the present invention.

To secure the splash eliminator strip 16 to the toilet bowl, the hook of the fastening mechanism is used to snap fit the mechanism onto the toilet bowl rim 20. The splash eliminator strip 16 is then permitted to flow on the surface of the water on a toilet bowl.

In one embodiment, a pair of floats 18 are attached to a free end of the splash eliminator strip 16 as an aid to help the splash eliminator strip 16 remain on the surface of the water. The floats 18 can be any object in which the material has a density less than water. The floats 18 in the example are small, light cylinders approximately 1.7 centimeters long and approximately 0.6 centimeters in diameter. The floats 18 each have a small hole through their length which allows for a string 32 to be threaded through the float 18. The ends of string 32 are secured to the splash eliminator strip 16 to secure the floats 18. The floats 18 can be attached to the splash eliminator 16 through any other suitable means. Suitable means for attaching the float 18 include, but are not limited to, thread, glue or any adhesive bonding material.

Although the present invention has been described with reference to preferred embodiments, workers skilled in the art will recognize that changes may be made in form and detail without departing from the spirit and scope of the invention.

1. A device for eliminating splash associated with urination in a toilet bowl having a rim, the device comprising:
a longitudinal strip of material for flotation on water in the toilet bowl having a length greater than a width; and
a mechanism capable of attaching the strip to the rim of the toilet bowl.

2. The device of claim 1 wherein at least one float is attached to a free end of the strip of material.

3. The device of claim 1 wherein the longitudinal strip of material comprises a non-woven synthetic cloth.

4. The device of claim 1 wherein the mechanism capable of attaching the strip to the rim is a deodorizer holder.

5. The device of claim 1 wherein the mechanism capable of attaching the strip to the rim is an adhesive tab.

6. A method of preventing back splash when men urinate from liquid in toilet bowls having a rim, the method comprising:
attaching a longitudinal strip of material to the rim of a toilet bowl such that the strip floats on the liquid in the toilet bowl.

7. The method claim 6 securing at least one float to a free end of the strip of material.

8. The method of claim 6 wherein the longitudinal strip is attached to the rim of the toilet bowl through a securing mechanism.

9. An anti-splash device for eliminating back splash from liquid in a toilet bowl during urination, the device comprising:
a longitudinal strip of material capable of floating on the surface of the liquid in the toilet bowl.
